(19) United States
(12) Patent Application Publication
(10) Pub. No.: US 2012/0080630 A1
(43) Pub. Date: Apr. 5, 2012

(54) FLOW PATH OPENING/CLOSING APPARATUS

(75) Inventors: Hiroishi Tsutomu, Tokyo (JP); Xu Ge, San Jose, CA (US)

(73) Assignee: CANON ANELVA CORPORATION, Kawasaki-shi (JP)

(21) Appl. No.: 13/238,350

(22) Filed: Sep. 21, 2011

(30) Foreign Application Priority Data
Oct. 1, 2010 (JP) 2010-223791
Aug. 22, 2011 (JP) 2011-180134

(51) Int. Cl. F16K 5/08

(52) U.S. Cl. 251/314

(57) ABSTRACT

There is provided a flow path opening/closing apparatus that can enhance airtightness so as to be capable of being used for a high-speed processing under a high pressure, while keeping advantages, which are a non-contact valve element, high exhausting capability, and high response speed. A butterfly valve includes a body having a flow path through which a fluid flows; and a valve element that can rotate in the flow path about a rotation axis vertical to the flow path, wherein a seal length extending wall for extending a seal length in a direction of the flow path at a gap, which is formed between the body and the valve element when the valve element is fully closed, is formed to project along an edge of the valve element.

### BACKGROUND OF THE INVENTION

1. Field of the Invention

The present invention relates to a flow path opening/closing apparatus, and more particularly, to a butterfly valve used for a vacuum processing apparatus.

2. Description of the Related Art

In a vacuum processing apparatus such as a semiconductor manufacturing apparatus, a process has conventionally been carried out under a condition in which a substrate is heated or cooled, according to demand for the process. In particular, a process of rapidly cooling a substrate is needed recently in a field of a recording media. A method of flowing a cooling gas so as to derive a heat of a substrate due to a thermal conduction is generally used as a method of cooling a substrate having high cleanness with a non-contact manner. Considering a cooling efficiency, this method needs a high pressure of about several hundred pascals.

In a recent manufacturing apparatus having high throughput, a time taken for a cooling process of a single substrate in one chamber is very short, such as about 5 seconds. Specifically, a cycle in which, after a pressure in a chamber is increased to about several hundred pascals so as to cool a substrate, a cooling gas filled in the chamber is exhausted to vacuum the chamber, and then, a substrate is discharged, has to be carried out in about 5 seconds. A butterfly valve has a high response speed, so that it is optimum for a pressure control of this usage. However, since a valve element is not in contact with a body, a gap is formed between the valve element and the body even if the valve element is fully closed. A gas is leaked from this gap, so that the pressure in the chamber cannot be increased.

As a method of solving the problem described above, a technique has been proposed in which a butterfly valve having a high response speed and an isolation valve having a high airtightness capable of isolating atmosphere from vacuum are combined (see Japanese Unexamined Patent Publication No. 2010-60133). The valve described in Japanese Unexamined Patent Publication No. 2010-60133 is provided with an O-ring at an end of a valve element, and also has a seat ring that is formed at the inside of a body and that reciprocates in the direction of a flow path. A butterfly valve executes a general pressure control. In order to attain a pressure higher than the pressure that can be controlled by the butterfly valve, the butterfly valve is fully opened, and then, the seat ring is moved toward the valve element with an air control so as to press the seat ring against the O-ring for realizing a sealing, whereby atmosphere and vacuum can be isolated. As described above, the technique described in Japanese Unexamined Patent Publication No. 2010-60133 has two functions, i.e., the pressure control function by the butterfly valve and the atmosphere sealing function by the seat ring.

### BRIEF SUMMARY OF THE INVENTION

The butterfly valve has advantages in that the valve element is formed in a non-contact manner, has a high exhausting capability, and high response speed. However, airtightness under high pressure is deteriorated from the viewpoint of the non-contact structure, when only the butterfly valve is mounted. Therefore, in the Japanese Unexamined Patent Publication No. 2010-60133, when the pressure in the chamber increases up to several hundred pascals, the butterfly valve is temporarily fully closed, and then, the seat ring is operated. Accordingly, the technique in Japanese Unexamined Patent Publication No. 2010-60133 needs a two-stage operation, which is unsuitable for a usage of a high-speed processing.

In view of the problem described above, the present invention aims to provide a flow path opening/closing apparatus that has enhanced airtightness so as to be capable of being employed for a high-speed processing under a high pressure, while maintaining advantages, which are a non-contact valve element, high exhausting capability, and high response speed.

The present invention is configured as described below in order to attain the foregoing object.

Specifically, the flow path opening/closing apparatus according to the present invention includes a body having a flow path through which a fluid flows; and a valve element that can rotate in the flow path about a rotation axis, which is vertical to the flow path, wherein a seal length extending wall for extending a seal length in a direction of the flow path at a gap, which is formed between the body and the valve element when the valve element is fully closed, is formed to project along an edge of the valve element.

According to the present invention, the seal length extending wall is formed along the edge of the valve element, whereby the seal length in the direction of the flow path at the gap, which is formed between the body and the valve element when the valve element is fully closed, is increased. Thus, the airtightness is increased, so that the apparatus can be used under high pressure region. Consequently, the present invention provides an effect that the apparatus has enhanced airtightness so as to be capable of being employed for a high-speed processing under a high pressure, while maintaining advantages, which are a non-contact valve element, high exhausting capability, and high response speed.

### BRIEF DESCRIPTION OF THE SEVERAL VIEWS OF THE DRAWINGS

FIGS. 1A to 1E are explanatory views illustrating a butterfly valve according to a first embodiment;

FIG. 2 is an explanatory view illustrating a pressure change, when a height of a seal length extending wall of the butterfly valve according to the first embodiment is changed;

FIGS. 3A and 3B are schematic views illustrating a butterfly valve according to a second embodiment;

FIGS. 4A to 4D are schematic views illustrating a butterfly valve according to a third embodiment;

FIG. 5 is an explanatory view illustrating a pressure change, when a height of a seal length extending wall of the butterfly valve according to the third embodiment is changed;

FIG. 6 are schematic views illustrating a butterfly valve according to a fourth embodiment;

FIGS. 7A to 7C are schematic views illustrating a butterfly valve according to a comparative example;

FIG. 8 is a schematic view illustrating an exhaust system in a general vacuum processing apparatus;

FIG. 9 is a sectional view illustrating a layer structure of a magnetic recording medium; and

FIG. 10 is a schematic view for explaining an in-line manufacturing apparatus to which the butterfly valve according to the present invention is applicable.

### DETAILED DESCRIPTION OF THE INVENTION

Embodiments of the present invention will be described with reference to the drawings. The present invention is not limited to these embodiments. Well-recognized or well-known techniques in this technical field are applied for components not particularly illustrated or described in the present specification.

### First Embodiment

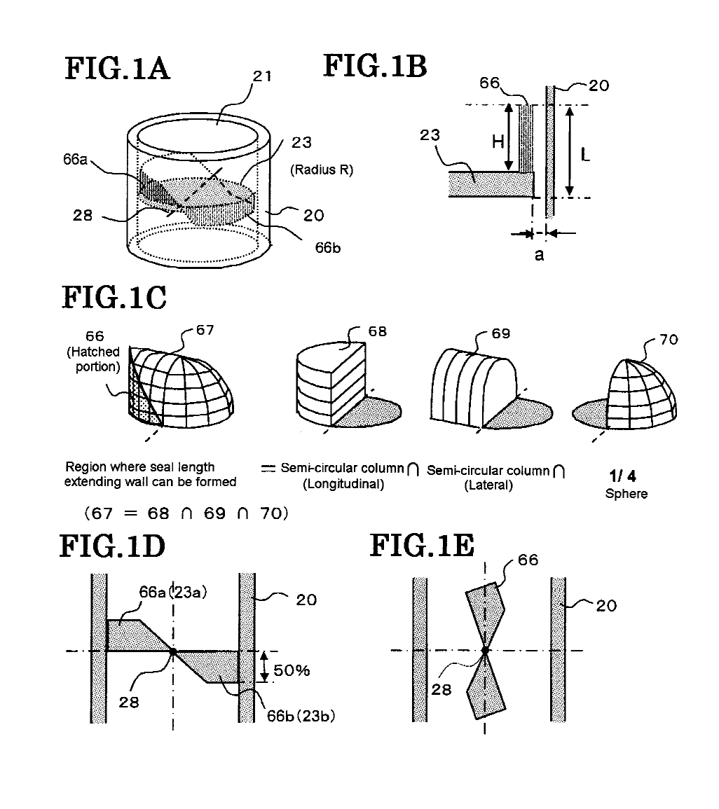

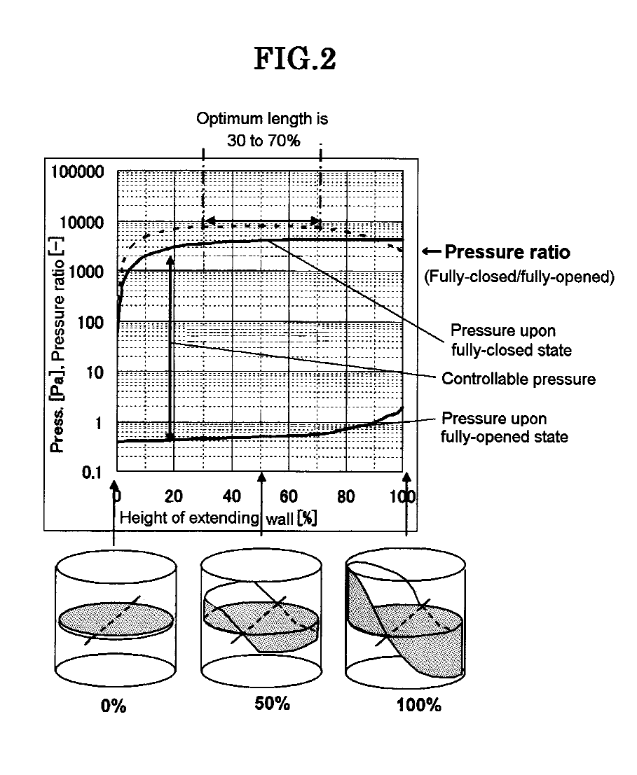

A butterfly valve according to a first embodiment will be described with reference to FIGS. 1A to 1E and 2 as one example of a flow path opening/closing apparatus according to the present invention. FIGS. 1A to 1E are explanatory views illustrating a butterfly valve of the first embodiment according to the present invention. Specifically, FIG. 1A is a schematic view illustrating the butterfly valve according to the present embodiment. FIG. 1B is a schematic sectional view illustrating the butterfly valve according to the present embodiment, wherein a portion thereof is enlarged. FIG. 1C is a view for explaining a region where a seal length extending wall can be formed. FIG. 1D is a schematic view illustrating the butterfly valve that is fully closed according to the present embodiment, as viewed from a direction of a valve stem. FIG. 1E is a schematic view illustrating the butterfly valve that is fully opened according to the present embodiment, as viewed from the direction of the valve stem. FIG. 2 is an explanatory view illustrating a pressure change, when a height of the seal length extending wall of the butterfly valve according to the first embodiment is changed.

A butterfly valve 63 is connected between a processing container (chamber) 61 and an exhaust pump 64 in a vacuum processing apparatus, for example (see later-described FIG. 8). A method of adjusting a pressure in the chamber 61 includes a method of controlling a flow rate of a gas from a gas introducing pipe 62, and a method of controlling a conductance by mounting a conductance variable valve (butterfly valve) 63 between the chamber 61 and the exhaust pump 64. An exhaust system in the vacuum processing apparatus will be described later.

Generally, a butterfly valve has mainly three functions. Firstly, the butterfly valve controls a valve element to control the pressure in the chamber 61. Secondly, the butterfly valve evacuates the gas with the valve element being fully opened so as to drop the ultimate pressure in the chamber 61 as much as possible. Thirdly, the butterfly valve flows a gas with the valve element being fully closed so as to increase the pressure in the chamber 61 as much as possible. The present invention aims to reinforce the sealing capability that is the third function.

Specifically, as illustrated in FIGS. 1A and 1B, the butterfly valve according to the present embodiment includes a body 20, a flow path 21, a valve element 23, a valve stem 28, and a seal length extending wall 66 that extends a seal length L in the flow path direction at a gap a between the body 20 and the valve element 23, the gap being formed when the valve element is fully closed. The seal length extending wall 66 is sometimes referred to as an “extending wall” below.

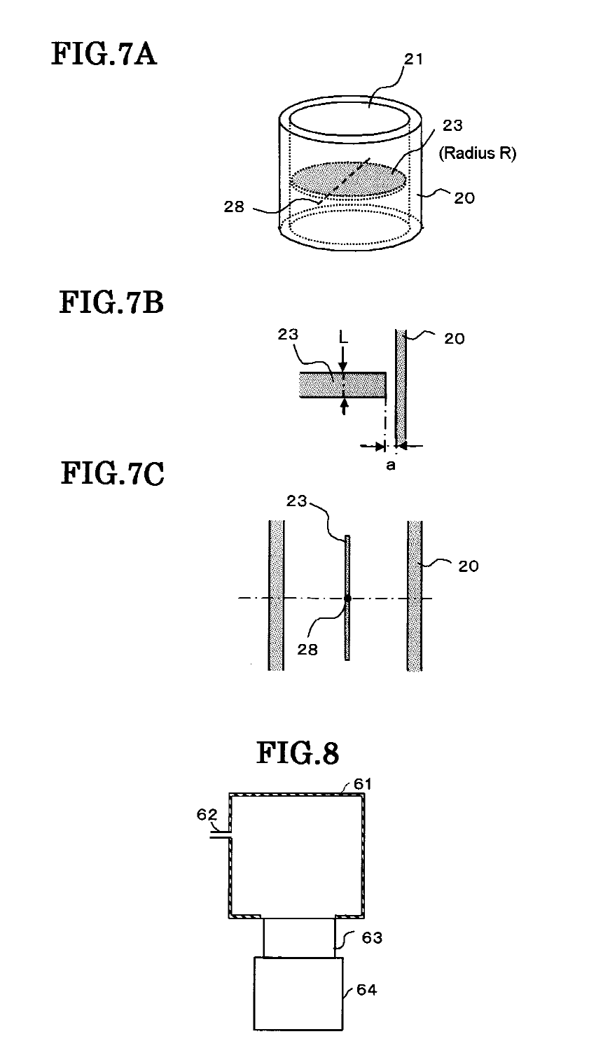

The body 20 in the present embodiment has a cylindrical shape, for example, and the flow path 21 of a fluid is formed to extend through the body 20. The valve element 23 that opens and closes the flow path 21 is supported in the flow path so as to be rotatable. The valve element 23 in the present embodiment has a disc-like shape, and mounted to the valve stem 28 that is a rotation axis. The valve stem 28 is supported in the direction vertical to the flow path 21 along the diameter of the body 20, wherein the valve element 23 can rotate about the valve stem 28. Specifically, the valve stem 28 is connected to an unillustrated stepping motor, wherein the valve element 23 can be moved in an optional angle by controlling the stepping motor. The valve element 23 having a conventional structure is a mere disc (see FIGS. 7A to 7C), while in the present invention, the extending wall 66 is formed to be orthogonal to the valve element 23 at the edge of the disc-like valve element 23. The shape of the valve element is determined according to the cross-sectional shape of the flow path 21 in the body 20. The valve element is not limited to have the disc-like shape, but may be a rectangular plate-like member, for example.

The capacity of the butterfly valve to be used varies depending upon the size of the vacuum processing apparatus. In the present embodiment, the valve having the flow path 21 with a diameter of 200 mm, which is used in a general semiconductor manufacturing apparatus, is basically used. Since the body 20, the valve element 23, the valve stem 28, and the extending wall 66 are used under vacuum, the material is a metal such as a stainless steel or aluminum, in most cases. In the present invention, it is supposed that a metal is used as the material. It is desirable that a metal having a small specific gravity, which can reduce a rotation moment, is employed for the valve element 23 and the extending wall 66, because they make a rotation. The function of the valve element 23 and the extending wall 66 is to block the flow of the air. Therefore, if a desired shape capable of blocking the flow of the air can be attained, a method of fixing the extending wall 66 to the valve element 23 can optionally be selected. The same effect can be obtained even by using a member having the valve element 23 and the extending wall 66 integrally formed.

The function of the extending wall 66 will next be described. In the butterfly valve, the gap a is formed between the valve element 23 and the body 20, even when the valve element 23 is closed. The gas is leaked from this gap a, so that the pressure in the chamber cannot be increased (see FIG. 7B). The valve element 23 is a movable portion that rotates in a non-contact manner. Therefore, the gap a is formed in order that the valve element 23 is not in contact with the body 20. The gap a is generally small, such as about 0.1 mm to 0.5 mm. However, the gas is leaked through this gap a, since a mean free path of a gas molecule under the pressure in the chamber of several hundred pascals is further small such as 0.01 mm or less. The conductance of the gap a with respect to the viscous flow is expressed by an equation (1) below.

Conductance ∝ α²/L (1)

As expressed in the equation (1), the conductance increases in proportion to a square of the gap a, while it is inversely proportional to the length (seal length) L of the gap a.

As illustrated in FIG. 1B, in the butterfly valve in the present embodiment, the gap a between the body 20 and the valve element 23 upon the fully-closed state is set to be the same as in the conventional butterfly valve. However, in the butterfly valve in the present embodiment, the extending wall 66 is formed to project from the edge of the valve element 23, whereby the seal length L in the flow path direction in the gap a is extended. Specifically, it is set to be long such as about 20 mm to 70 mm, compared to 0.2 mm to 4.0 mm in the conventional structure. Specifically, in the butterfly valve in the present embodiment, the seal length L in the flow path direction at the gap a is set to be long, whereby the conductance becomes very small. Therefore, the airtightness of the vacuum chamber upon the fully-closed state of the butterfly valve can be enhanced.

The optimum shape of the extending wall 66 will be examined next. As is understood from FIGS. 1B and 1D, extending walls 66a and 66b are designed so as to be symmetrical with respect to the valve stem 28. The reason for this configuration is because, if they are not symmetric with respect to a point, a center of gravity of an inertia moment is shifted from the valve stem 28, which deteriorates a smooth rotation.

Specifically, the valve element 23 has a first region 23a and a second region 23b, across the valve stem 28, facing forward in the rotating direction of the valve element 23. The first seal length extending wall 66a is formed so as to face forward in the rotating direction of the valve element 23 to project from the edge of the first region 23a. On the other hand, the second seal length extending wall 66b is formed so as to face forward in the rotating direction of the valve element 23 to project from the edge of the second region 23b. The first seal length extending wall 66a and the second seal length extending wall 66b are formed to be symmetric with respect to the valve stem 28.

There is a limitation on the height H of the extending wall 66. When the height H of the extending wall 66 becomes larger than the radius R of the valve element 23, the extending wall 66 hinders the body 20 when the valve element 23 is titled at an angle of 90° to be fully opened. Therefore, the height H of the extending wall 66 of the butterfly valve according to the present embodiment has to be shorter than the radius R of the valve element 23. Considering this limitation, the region where the extending wall 66 can be formed takes a shape 67 illustrated in FIG. 1C. This region is specified as described below. Specifically, two semi-circular columns 68 and 69, each having a radius R and height R, and a shape 70 formed by cutting a sphere of the radius R into 4 are prepared, and the region is specified as the portion where these three shapes are superimposed. FIG. 1C illustrates the semi-circular column 68 with the radius R and height R (that stands), the semi-circular column 69 with the radius R and height R (that is laid down), the shape 70 formed by cutting the sphere with the radius R into 4, and the region 67 where the extending wall can be formed.

Which region the extending wall 66 should be formed will next be examined. As is understood from the equation (1), when the gap a between the extending wall 66 and the body 20 increases in even the slightest amount, the conductance increases, so that the gas might be leaked. In this case, there is no point in forming the extending wall 66. Accordingly, the region where the extending wall 66 should be formed is a curved surface indicated by a hatched portion in FIG. 1C. Specifically, forming the extending wall 66 along the edge of the valve element 23 is necessary and sufficient condition.

The height H of the extending wall 66 will again be examined. The higher the height H of the extending wall 66 is, the more the conductance is reduced when the valve element is fully closed, whereby the airtightness of the chamber is enhanced. However, when the valve element is fully opened, the side face of the extending wall 66 hinders the exhaust, whereby exhaust time might be increased or the ultimate pressure might be deteriorated due to the reduction in the exhaust speed. FIG. 2 illustrates this situation in the form of a graph, wherein an abscissa axis indicates the height (mm) of the extending wall/radius R (mm) of the valve element.

The upper solid line indicates calculation data when a gas in an amount of 100 sccm is introduced into the chamber, and with this state, the valve element 23 is fully closed to increase the pressure. In the conventional butterfly valve (height of 0%), the pressure is approximately 60 pascals. However, when the extending wall 66 is formed, it is found that the pressure in the chamber rapidly rises, i.e., rises up to about a maximum of 4000 pascals.

On the other hand, it is also important to what degree the conductance can be increased when the valve element 23 is fully opened, from the viewpoint of vacuumizing the chamber. The fully-opened state means that the exhaust conductance becomes the maximum. Specifically, in the conventional butterfly valve, the valve element 23 is a disc having a plane, so that the conductance becomes the maximum when the valve element 23 is tilted with respect to the flow path 21 at an angle of 90° (see FIG. 7C). However, the butterfly valve according to the present embodiment has formed thereon the extending wall 66, and has a three-dimensional structure. Therefore, the angle by which the projected sectional area along the flow path direction becomes the minimum when the valve element 23 rotates becomes the fully-opened angle. This angle differs depending upon the height H of the extending wall 66. When the extending wall 66 has the height corresponding to 20% of the radius R, the angle becomes 81°, and when the extending wall 66 has the height corresponding to 70% of the radius R, the angle becomes 67°, which means that the angle becomes smaller than 90°. The lower solid line in FIG. 2 indicates the pressure upon the fully-opened state. It is found that, when the height H of the extending wall 66 is increased, the conductance is gently deteriorated, and the pressure rapidly rises near the height corresponding to 100%. Specifically, when the height H of the extending wall 66 increases, the exhaust characteristic upon the fully-opened state is deteriorated.

There is a trade-off relation between the airtightness and the exhaust characteristic. Therefore, a well-balanced height has to be selected. As for the characteristic of the pressure control valve, it is desirable to be capable of adjusting the pressure in a wide range from a low pressure to a high pressure. As an index of this, the ratio (corresponding to a ratio of conductance) of the pressure upon the fully-opened state and the pressure upon the fully-closed state is obtained, and this is indicated by a dotted line. Specifically, as this value is great, it can be said that the controllable pressure range is great. It is found from this dotted line that the controllable pressure range becomes the maximum when the extending wall 66 has the height corresponding to 30 to 70% of the radius R. Actually, it is considered that, if the valve is used for the purpose placing importance on the airtightness, the height of the extending wall 66 is preferably about 70% of the radius R, and if the valve is used for the purpose placing importance on the exhaust characteristic, the height is about 30% of the radius R.

As described above, the butterfly valve according to the present embodiment has enhanced airtightness so as to be capable of being employed for a high-speed processing under a high pressure, while maintaining advantages, which are the non-contact valve element 23, high exhausting capability, and high response speed. Specifically, according to the butterfly valve (having the height corresponding to 50% of the radius R) in the present embodiment, the pressure upon the fully-closed state can greatly be increased from 60 pascals, which is the pressure in the conventional structure, to 4000 pascals. The controllable pressure range can also be 140 times to 8000 times as large as the conventional structure, which means the butterfly valve according to the present invention can be used in a wide pressure range.

### Second Embodiment

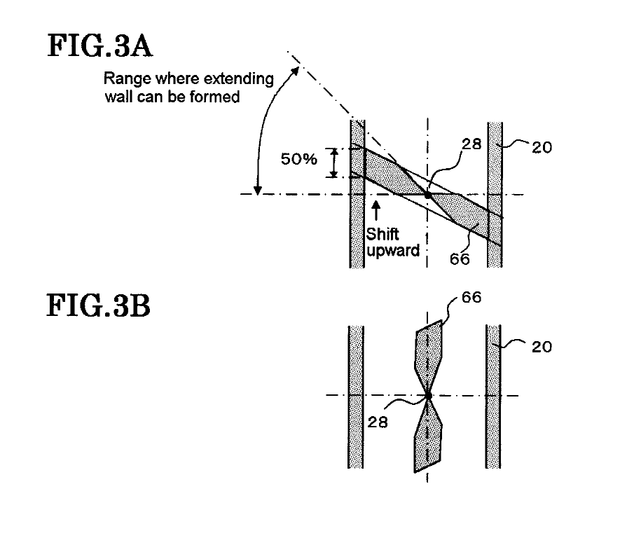

A butterfly valve according to a second embodiment will be described next with reference to FIGS. 3A and 3B. FIGS. 3A and 3B are schematic views illustrating a butterfly valve according to the second embodiment. FIGS. 7A to 7C are schematic views illustrating a butterfly valve according to a comparative example (a conventional butterfly valve).

In the butterfly valve (having a height corresponding to 50% of the radius R) according to the first embodiment, the pressure at the fully-opened state rises from 0.4 Pascal, which is the value in the conventional structure, to 0.6 Pascal, which shows that the conductance upon the exhaust is deteriorated. An apparatus, such as a film-forming apparatus, in which the ultimate pressure is important, desirably avoids the deterioration in the conductance during the exhaust as much as possible.

The butterfly valve according to the comparative example (conventional butterfly valve) will schematically be described with reference to FIGS. 7A to 7C. As illustrated in FIG. 7A, a disk-like valve element 23 is provided at the inside of the body 20. When the chamber is vacuumized, the valve element 23 is moved to the position parallel to the flow path 21 in order not to hinder the exhaust as illustrated in FIG. 7C. This state is referred to as the fully-opened (opening degree=100%) state. On the contrary, the state in which the valve element 23 is located at the position vertical to the flow path 21 is referred to as the fully-closed state (opening degree=0%). When the process is performed, a gas has to be introduced into the chamber. When the valve element 23 is in the fully-opened state in this case, the gas is efficiently exhausted, so that the pressure in the chamber drops. In order to rise the pressure, the opening degree of the valve element 23 is decreased so as to block the flow of the gas. With this, the conductance between the body 20 and the valve element 23 is reduced, resulting in that the pressure in the chamber can be increased.

When the butterfly valve in the comparative example is fully opened to exhaust the gas, the valve element 23 is located at the position parallel to the flow path 21 as illustrated in FIG. 70. In this case, the projected sectional area along the flow path direction becomes the minimum. The ratio of the valve element 23 to the sectional area of the flow path 21 is about 4% in terms of an area ratio.

FIG. 1E illustrates the state in which the butterfly valve (having the height corresponding to 50% of the radius R) according to the first embodiment is used to exhaust the gas. In this case, when the valve element 23 is rotated at an angle of about 70° from the fully-closed state, the projected sectional area along the flow path direction becomes the minimum. The ratio of the valve element 23 to the sectional area of the flow path 21 in this case is 40% in terms of an area ratio, and it is considered to cause the deterioration in the exhaust characteristic.

FIGS. 3A and 3B illustrate the configuration of the butterfly valve (having a height corresponding to 50% of the radius R) according to the present embodiment. In the first embodiment, the extending wall 66 is provided directly on the valve element 23. On the other hand, the extending wall 66 is arranged as being shifted in the flow path direction in the present embodiment. Further, the valve element 23 is bent so as not to form a gap between the valve element 23 and the extending wall 66. The extending wall 66 is shifted so as to allow the projected sectional area along the flow path direction to become the minimum in order to reduce the conductance as much as possible upon the fully-opened state (exhaust).

With this, only 29% of the flow path 21 is covered by the extending wall 66 during the exhaust in the present embodiment, while 40% of the flow path 21 is covered by the extending wall 66 in the first embodiment. On the other hand, although the extending wall 66 is arranged as being shifted in the flow path direction, the height L of the extending wall 66 in the flow path direction at the respective places is the same as that in the first embodiment. Therefore, the conductance upon the fully-closed (airtight) state is equal to that in the first embodiment.

As a result, the present embodiment can minimize the deterioration in the conductance upon the fully-opened state (exhaust), while keeping the pressure upon the fully-closed (airtight) state, compared to the first embodiment. Accordingly, compared to the first embodiment, the conductance upon the fully-opened state of the valve element 23 can be increased, and the ultimate pressure and the exhaust time of the chamber can be improved according to the present embodiment.

### Third Embodiment

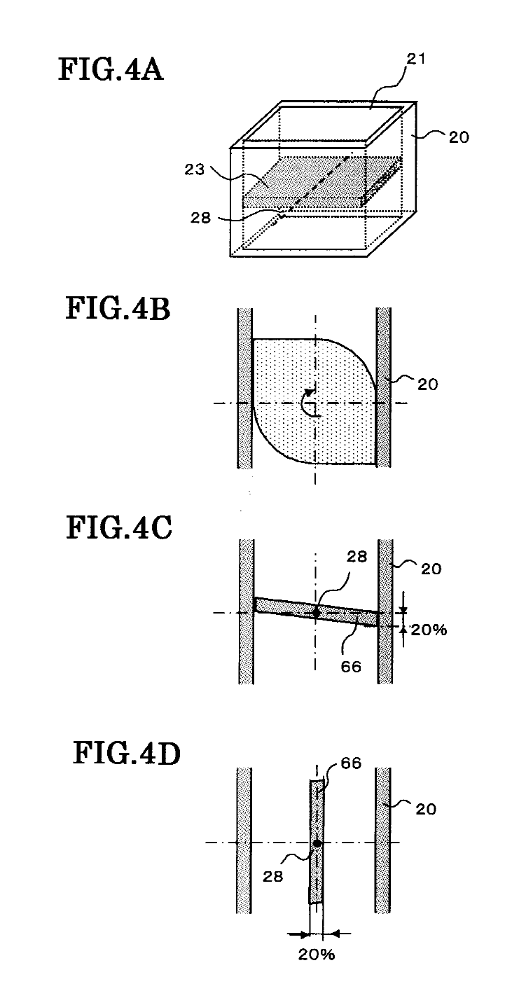

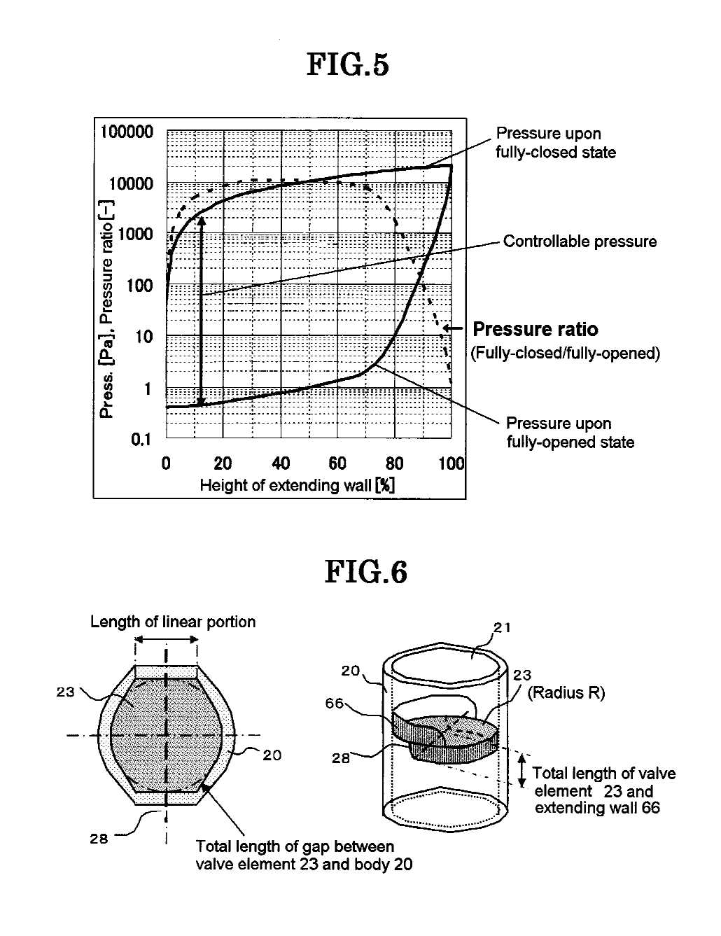

A butterfly valve according to a third embodiment will be described with reference to FIGS. 4A to 4D and 5. FIGS. 4A to 4D are schematic views illustrating a butterfly valve according to the third embodiment. FIG. 5 is an explanatory view illustrating a pressure change, when a height of a seal length extending wall of the butterfly valve according to the third embodiment is changed.

In the first embodiment, the pressure upon the fully-closed state is 70 times as high as the pressure in the conventional structure by mounting the extending wall 66. However, there may be the case in which this is not yet sufficient depending upon the usage. Considering the first embodiment in detail, a gas might be leaked from the portion near the valve stem 28 where the extending wall 66 is not formed. Therefore, in order to enhance airtightness, the leakage from the gap near the valve stem 28 has to be reduced.

The reason why the extending wall 66 cannot be formed near the valve stem 28 is because the surface near the valve stem 28 is curved. If the extending wall 66 is formed at this portion, the extending wall 66 and the body 20 interfere with each other during the rotation, resulting in that the valve element cannot rotate. In order to allow the valve element to be rotatable by forming the extending wall 66, the surface near the valve stem 28 has to be planar, not curved.

The structure in which the cross-sectional shape of the flow path 21 is not circle but regular tetragon is considered as an example where the surface near the valve stem 28 is planar. As illustrated in FIG. 4A, the cross-sectional shape of the flow path 21 is regular tetragon, wherein a length of one side is set to be twice the radius R. According to this, the cross-sectional shape of the valve element 23 viewed from the direction of the flow path 21 is changed to be regular tetragon having the same size.

When the cross-sectional shape of the flow path 21 is regular tetragon, the portion (range) where the extending wall 66 can be formed is relatively simple, which is as illustrated in FIG. 4B. The necessary region for the extending wall 66 is determined out of this region. For simplification, the tendency is confirmed with the height H of the extending wall 66 being changed, as in the first embodiment in which the cross-sectional shape of the flow path 21 is a circle.

FIG. 5 illustrates the change in the pressure in the chamber when the height H of the extending wall 66 is changed from 0 to 100% with the use of the butterfly valve according to the present embodiment. There is not so great difference between this case and the first embodiment in which the cross-sectional shape of the flow path 21 is a circle. However, when the cross-sectional shape of the flow path 21 is circular, the affect of the leakage from the vicinity of the valve stem 28 even in the fully-closed state is great, and even if the height H of the extending wall 66 increases, the pressure in the chamber is up to 4000 pascals. On the other hand, when the cross-sectional shape of the flow path 21 is a regular tetragon, the extending wall 66 can be formed on all portions on the circumference of the valve element 23. Therefore, the pressure can be increased as a maximum of 20000 pascals upon the fully-closed state, which is different from the first embodiment.

On the other hand, as in the case where the cross-sectional shape of the flow path 21 is a circle, the conductance upon the fully-opened state (exhaust) is deteriorated when the height H of the extending wall 66 increases. Therefore, the optimum height H is 20 to 60% of the radius R. For example, FIG. 4C illustrates the sectional view of the butterfly valve according to the present embodiment when the height of the extending wall is 20% of the radius R. Although the height H of the extending wall is low such as 20% of the radius R, the conductance same as that in the first embodiment (wherein the height is 50% of the radius R) can be obtained. As is understood from FIG. 4D, the ratio of the extending wall 66 to the sectional area of the flow path 21 during the exhaust is small such as 13%, which shows that the exhaust conductance is also improved compared to the first embodiment.

According to the present embodiment, the cross-sectional shape of the flow path 21 formed in the body 20 is a square, wherein a linear component vertical to the valve stem 28 is formed near the valve stem 28. Accordingly, the extending wall 66 can be formed near the valve stem 28, whereby the airtightness can more be enhanced.

### Fourth Embodiment

A butterfly valve according to a fourth embodiment will be described next with reference to FIG. 6. FIG. 6 are schematic views illustrating a butterfly valve according to the fourth embodiment.

In the third embodiment, the structure in which the cross-sectional shape of the flow path 21 is regular tetragon is considered as an example in which the linear component vertical to the valve stem 28 is formed near the valve stem 28. Other than the cross-sectional shape of regular tetragon, the above-mentioned concept is established even by an optional shape such as a regular polygon, or a combination of rectangle and ellipse. In this case, it is necessary as the condition required for the cross-sectional shape that, when the valve element 23 is rotated, the length of the linear component on the cross-section of the flow path 21 is longer than the total length of the valve element 23 and the seal length extending wall 66 in order to prevent the interference between the valve element 23 and the body 20. On the other hand, when the length of the linear component on the cross-section of the flow path 21 increases, the amount of the leaking gas upon the fully-closed state also increases.

Considering these two points, it is found that the length of the linear component on the cross-sectional shape of the flow path 21 is made equal to the total length of the valve element 23 and the extending wall 66. FIG. 6 illustrate examples of a combination with a turbo-molecular pump having a circular opening. The cross-sectional shape of the flow path 21 in this example has a linear component having a length equal to the total length of the valve element 23 and the extending wall 66 near the valve stem 28, and the other portions that are linking the ends of the linear component with the circular components at the shortest path in the outside region of a circle with the radius R (circular component). With this shape, the total length at the gap between the valve element 23 and the body 20 is reduced by 21%, compared to the shape of regular tetragon. Therefore, extra gas leakage upon the fully-closed state is reduced, whereby the airtightness is enhanced. The height of the extending wall in both embodiments is set to be 20% of the radius R.

According to the present embodiment, the total length of the gap a between the valve element 23 and the body 20 in the circumferential direction can be minimized, whereby the extra gas leakage upon the fully-closed state of the valve element 23 is reduced, and hence, the airtightness can more be enhanced.

### Fifth Embodiment

An example of application of the butterfly valve according to the first to fourth embodiments will next be described.

[Vacuum Processing Apparatus]

A vacuum processing apparatus to which the butterfly valve according to the first to fourth embodiments is applied will be described with reference to FIG. 8. FIG. 8 is a schematic view illustrating an exhaust system in a general vacuum processing apparatus.

As illustrated in FIG. 8, an exhaust port is provided at an end face of the chamber 61, wherein the chamber 61 is evacuated by the exhaust pump 64. During the process, a gas is introduced into the chamber 61 from the gas introducing tube 62, and then, the gas is exhausted to the outside of the chamber 61 by the exhaust pump 64. The above-mentioned butterfly valve (conductance variable valve) 63 is mounted between the exhaust port and the exhaust pump 64. With this, the flowability (=conductance) of the gas is changed, whereby the pressure in the chamber 61 is adjusted.

Since the butterfly valve (conductance variable valve) 63 according to the present invention is applied, not only advantages of having a pressure adjusting function, being lightweight, and having a high response speed can be attained, but also the airtightness upon the fully-closed state of the butterfly valve 63 can be enhanced. The butterfly valve according to the present invention has a small footprint, and small inertia moment, whereby the response speed is high. Since the butterfly valve has a non-contact form, it has an advantage of not generating dust. Accordingly, the butterfly valve according to the present invention is suitable for the vacuum processing apparatus.

[Magnetic Recording Medium]

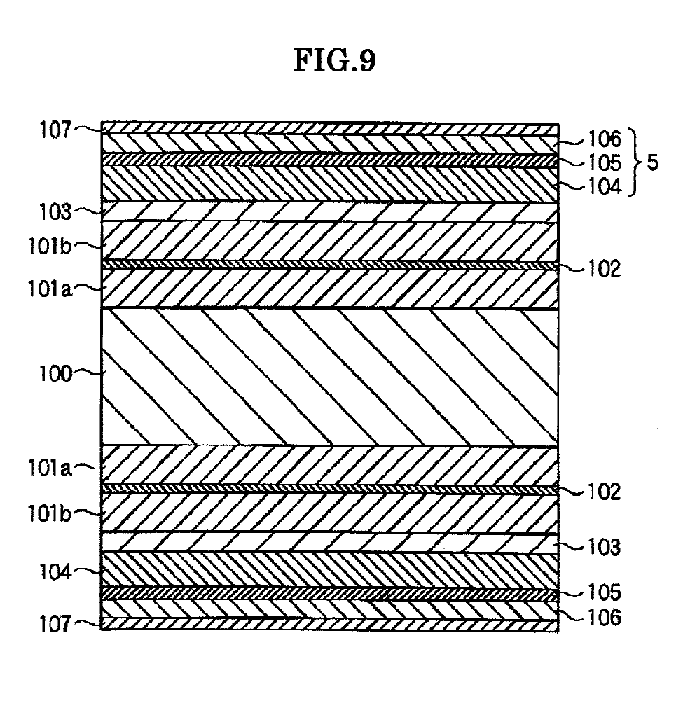

A magnetic recording medium will next be described as an example of a substrate that is processed by the vacuum processing apparatus or a later-described in-line thin film forming apparatus. FIG. 9 is a sectional view illustrating a layer structure of a magnetic recording medium.

As illustrated in FIG. 9, the magnetic recording medium has, for example, a substrate 100, and a first soft magnetic layer 101a successively stacked on both surfaces or on one surface of the substrate 100. The magnetic recording medium also has a spacer layer 102, a second soft magnetic layer 101b, a seed layer 103, a magnetic layer 104, an exchange coupling control layer 105, a third soft magnetic layer 106, and a protection layer 107.

As for the material of the substrate 100, a non-magnetic material such as a glass, Al alloy having formed thereon an NiP plating film, ceramics, flexible resin, and Si can be used, those of which are generally used as a substrate of a magnetic recording medium. The substrate 100 in the present embodiment is a disc-like member having a hole at its center. However, the substrate is not limited thereto. For example, the substrate may be a rectangle member.

The first soft magnetic layer 101a deposited on the substrate 100 is a layer that is preferably formed for enhancing a read/write property under a control of a magnetic flux from a magnetic head used for a magnetic recording. However, this layer can be eliminated. As a material for the first soft magnetic layer 101a, CoZrNb, CoZrTa, and FeCoBCr can be used, for example, according to a film immediately above the first soft magnetic layer 101a.

Ru and Cr can be used, for example, as a material for the spacer layer 102. The second soft magnetic layer 101b deposited on the spacer layer 102 is the same as the first soft magnetic layer 101a. The first soft magnetic layer 101a, the spacer layer 102, and the second soft magnetic layer 101b form a soft underlayer.

The seed layer 103 deposited on the soft underlayer is a layer that is preferably formed immediately below the magnetic layer 104 in order to preferably control a crystal orientation, crystal grain size, grain size distribution, and grain boundary segregation of the magnetic layer 104. MgO, Cr, Ru, Pt, and Pd can be used, for example, as a material for the seed layer 103.

A magnetic recording layer 5 includes the magnetic layer 104 having a large Ku value, the exchange coupling control layer 105, and a third soft magnetic layer 106 having a small Ku value.

The magnetic layer 104 deposited on the seed layer 103 and having a large Ku value covers the Ku value of the whole magnetic recording layer, so that it is preferably made of a material having as large Ku value as possible. As a material having a magnetization easy axis vertical to the substrate surface, and exhibiting the above-mentioned performance, a material having a structure in which a ferromagnetic particle is separated by a non-magnetic grain boundary component of an oxide can be used. For example, a material having an oxide added to a ferromagnetic material containing at least CoPt, such as CoPtCr—SiO₂, or CoPt—SiO₂, can be used. Co₅₀Pt₅₀, Fe₅₀Pt₅₀, and Co_{50-y}Fe_{y}Pt₅₀ can also be used.

The exchange coupling control layer 105 deposited on the magnetic layer 104 contains a crystalline metal or alloy, and an oxide. As a material for the crystalline metal or alloy, Pt or Pd, or an alloy thereof can be used, for example. As for the crystalline alloy, an alloy of an element selected from Co, Ni, and Fe and a non-magnetic metal can be used, for example.

The strength of the exchange coupling force between the magnetic layer 104 and the third soft magnetic layer 106 can most simply be controlled by changing the thickness of the exchange coupling control layer 105. The thickness is desirably set to be 0.5 to 2.0 nm, for example.

The third soft magnetic layer 106 deposited on the exchange coupling control layer 105 mainly has a function of reducing a magnetization switching field, so that it is preferably made of a material having as small Ku value as possible. Co, NiFe, and CoNiFe can be used for this material, for example.

The protection layer 107 deposited on the third soft magnetic layer 106 is formed in order to prevent a damage caused by a contact between a head and a surface of a medium. A film having a single component of C, SiO₂, or ZrO₂ or having these materials as a major component, and containing an additive element can be used as the protection layer 107.

[In-Line Manufacturing Apparatus]

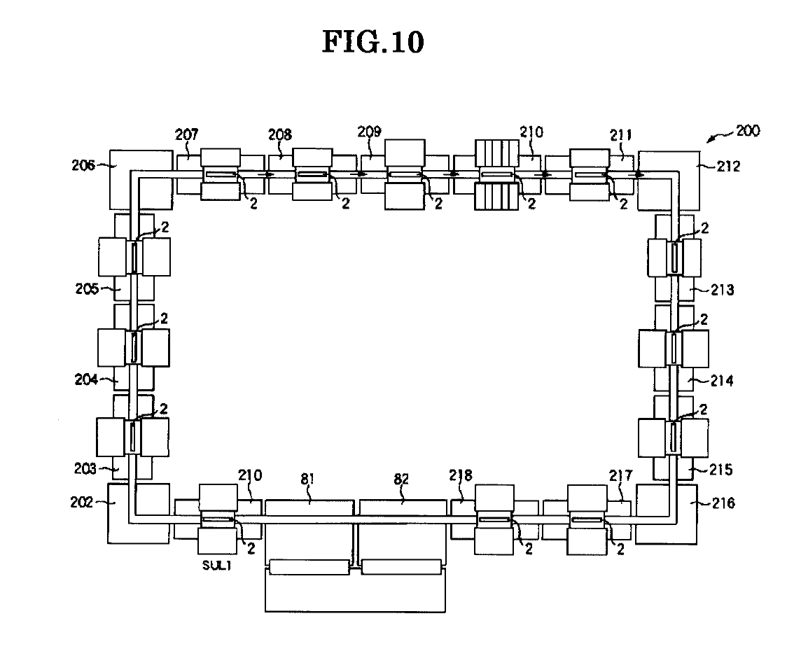

One example of an in-line manufacturing apparatus (hereinafter referred to as a “magnetic recording medium manufacturing apparatus”) to which the butterfly valve according to the first to fourth embodiments is applicable will be described next. FIG. 10 is a schematic view for explaining an in-line manufacturing apparatus to which the butterfly valve according to the present invention is applicable.

As illustrated in FIG. 10, the magnetic recording medium manufacturing apparatus includes, on a carrier 2, a load lock chamber 81 for mounting the substrate 100 (FIG. 9), and an unload lock chamber 82 for collecting the substrate 100 from the carrier 2. The magnetic recording medium manufacturing apparatus also includes plural chambers 201, 202, 203, 204, 205, 206, 208, 209, 210, 211, 212, 213, 214, 215, 216, 217, and 218, those of which are arranged along an outline of a rectangle. A conveying path is formed along the load lock chamber 81, the chambers 201 to 218, and the unload lock chamber 82. The conveying path is provided with the plural carriers 2 on which the substrate 100 can be mounted. A processing time (tact time) needed for the process at each chamber is determined beforehand. After the processing time (tact time) has elapsed, the carriers 2 are successively conveyed to the next chamber.

In order to allow the magnetic recording medium manufacturing apparatus to process about 1000 substrates per 1 hour, the tact time in one chamber is about 5 seconds or less, desirably about 3.6 seconds or less.

The load lock chamber 81, the unload lock chamber 82, and each of the chambers 201 to 218 are chambers that can exhaust a gas with a dedicated or shared exhaust system. A gate valve (not illustrated) is provided at the boundary of each of the load lock chamber 81, the unload lock chamber 82, and the chambers 201 to 218.

Specifically, the chamber 201 in the magnetic recording medium manufacturing apparatus deposits the first soft magnetic layer 101a on the substrate 100. The direction changing chamber 202 changes the conveying direction of the carrier 2. The chamber 203 deposits the spacer layer 102 onto the first soft magnetic layer 101a. The chamber 204 deposits the second soft magnetic layer 101b on the spacer layer 102. The chamber 205 deposits the seed layer 103 on the second soft magnetic layer 101b. The direction changing chamber 206 changes the conveying direction of the carrier 2. The magnetic recording medium manufacturing apparatus also has a chamber 207 (first heat chamber) and the chamber 208 (second heat chamber) for preheating the substrate 100. The chamber 209 can form the seed layer 103.

The chamber 210 can function as a sputtering apparatus for depositing the magnetic layer 104 on the seed layer 103. The cooling chamber 211 cools the substrate 100 on which the magnetic layer 104 is deposited. In order to cool the substrate with a high speed, a cooling gas (hydrogen) is introduced into the cooling chamber 211. From the viewpoint of a cooling efficiency, a high pressure such as several hundred pascals is needed. Therefore, the butterfly valve 63 according to the present invention is employed for the cooling chamber 211. The direction changing chamber 212 changes the conveying direction of the carrier 2. The cooling chamber 213 cools the substrate 100. The chamber 214 deposits the exchange coupling control layer 105 onto the magnetic layer 104. The chamber 215 deposits the third soft magnetic layer 106 onto the exchange coupling control layer 105. The direction changing chamber 216 changes the conveying direction of the carrier 2. The chambers 217 and 218 form the protection layer 107.

The butterfly valve according to the first to fourth embodiments is provided as a pressure control unit for the cooling chamber 211 that needs high pressure such as several hundred pascals.

The preferred embodiments of the present invention have been described above. However, they are only illustrative of the present invention, and various aspects different from the above-mentioned embodiments are possible without departing from the scope of the present invention. The butterfly valve according to the present invention can be configured by combining any features described in the respective embodiments.

For example, in the embodiments described above, the extending wall 66 is formed to project around the valve element 23 in the direction of the flow path. From the viewpoint of fluid dynamics, there are many irregularities, so that turbulent flow or resonance might be generated, which might cause malfunction. It is considered that this situation can be avoided by forming a flat plate over the extending wall 66 or forming the extending wall 66 to be closed toward the valve stem 28.

What is claimed is:

1. A flow path opening/closing apparatus comprising:
a body having a flow path through which a fluid flows; and
a valve element that can rotate in the flow path about a rotation axis vertical to the flow path, wherein
a seal length extending wall for extending a seal length in a direction of the flow path at a gap, which is formed between the body and the valve element when the valve element is fully closed, is formed to project along an edge of the valve element.

2. The flow path opening/closing apparatus according to claim 1, wherein
the valve element has a first region and a second region facing forward in the rotating direction of the valve element across the rotation axis,
a first seal length extending wall is formed to project along an edge of the first region so as to face forward in the rotating direction of the valve element, and
a second seal length extending wall is formed to project along an edge of the second region so as to face forward in the rotating direction of the valve element.

3. The flow path opening/closing apparatus according to claim 2, wherein the height of the first seal length extending wall and the height of the second seal length extending wall are 30 to 70% of the radius of the valve element.

4. The flow path opening/closing apparatus according to claim 2, wherein the first seal length extending wall and the second seal length extending wall are formed so as to be symmetric with respect to the rotation axis.

5. The flow path opening/closing apparatus according to claim 1, wherein the position of the seal length extending wall is formed as being shifted toward the direction of the flow path in order that a projected sectional area of the valve element along the direction of the flow path becomes the minimum, when the valve element is tilted in order that the conductance with respect to the flow path becomes the maximum.

6. The flow path opening/closing apparatus according to claim 1, wherein a cross-sectional shape of the flow path formed in the body includes a linear component vertical to the rotation axis near the rotation axis.

7. The flow path opening/closing apparatus according to claim 6, wherein
the cross-sectional shape of the flow path includes the linear component vertical to the rotation axis near the rotation axis, and a circular component,
the length of the linear component is equal to the total length of the valve element and the seal length extending wall, and
the other portion is formed by linking the end of the linear component with the circular component at the shortest path in the region outside the circular component.

8. A vacuum processing apparatus comprising the flow path opening/closing apparatus according to claim 1 between a chamber and an exhaust pump.

9. An in-line manufacturing apparatus comprising a cooling chamber provided with the flow path opening/closing apparatus according to claim 1.
